(19) United States
(12) Patent Application Publication
(10) Pub. No.: US 2007/0210710 A1
(43) Pub. Date: Sep. 13, 2007

(54) Gas excited emitting device and flat display apparatus

(76) Inventors: Hyoung-Bin Park, Suwon-si (KR); Seung-Hyun Son, Suwon-si (KR); Sang-Hun Jang, Suwon-si (KR); Gi-Young Kim, Suwon-si (KR); Sung-Soo Kim, Suwon-si (KR); Hidekazu Hatanaka, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/600,692

(22) Filed: Nov. 16, 2006

(30) Foreign Application Priority Data
Nov. 22, 2005 (KR) 10-2005-0111980

(51) Int. Cl. H01J 17/49

(52) U.S. Cl. 313/582

(57) ABSTRACT

Provided is a gas excited emitting device, which emits light by exciting a gas. The device includes: a first substrate and a second substrate facing each other with a constant distance and forming a space in which an excitation gas is filled; a plurality of electrodes disposed between the first substrate and the second substrate; and an electron emission source, and at least one of the first substrate and the second substrate is a plastic substrate.

### CROSS-REFERENCE TO RELATED PATENT APPLICATIONS

This application claims the benefit of Korean Patent Application No. 10-2005-0111980, filed on Nov. 22, 2005, in the Korean Intellectual Property Office, the disclosure of which is incorporated herein in its entirety by reference.

### BACKGROUND OF THE INVENTION

1. Field of the Invention

The present embodiments relate to a gas excited emitting device and a flat panel display apparatus including the same.

2. Description of the Related Art

Flat panel display apparatuses, for example, plasma display panels form images using electric discharge, and have been widely used because of desired display properties such as high brightness and wide viewing angle. In the plasma display panel, a gas discharge occurs between electrodes by a direct current (DC) voltage or an alternating current (AC) voltage applied to the electrodes, and a phosphor material is excited by ultraviolet rays that are generated during the gas discharge and emits visible light.

Plasma display panels can be classified as facing discharge plasma display panels and surface discharge plasma display panels according to the arrangements of the electrodes. In a facing discharge plasma display panel, pairs of sustain electrodes are disposed on an upper substrate and a lower substrate, and thus, a discharge occurs perpendicularly to the substrate. In a surface discharge plasma display panel, pairs of sustain electrodes are disposed on the same substrate, and thus, a discharge occurs in parallel to the substrate.

FIG. 1 illustrates a conventional AC surface discharge plasma display panel according to the conventional art. FIG. 2 is a cross-sectional view of a part of the plasma display panel of FIG. 1.

Referring to FIGS. 1 and 2, a lower substrate 10 and an upper substrate 20 face each other with a predetermined distance therebetween to form a discharge space, in which a plasma discharge can occur. A plurality of address electrodes 11 are formed on an upper surface of the lower electrode 10, and the address electrodes 11 are embedded by a first dielectric layer 12. A plurality of barrier ribs 13 defining discharge areas to form a plurality of discharge cells 14 and preventing electric and optical cross talks from generating between the discharge cells 14 are formed on an upper surface of the first dielectric layer 12. Red (R), green (G), and blue (B) phosphor layers 15 are applied on inner surfaces of the discharge cells 14. In addition, a discharge gas that generally includes Xe is filled in the discharge cells 14.

The upper substrate 20 is a transparent substrate, through which visible light can transmit, and is coupled to the lower substrate 10, on which the barrier ribs 13 are formed. A pair of sustain electrodes 21a and 21b are formed on the lower surface of the upper substrate 20 at each of the discharge cells 14 in a direction of crossing the address electrodes 11. Here, the sustain electrodes 21a and 21b are mainly formed of a transparent conductive material such as indium tin oxide (ITO) so that the visible light can transmit through the sustain electrodes 21a and 21b. In addition, in order to reduce line resistances of the sustain electrodes 21a and 21b, bus electrodes 22a and 22b having lower widths than those of the sustain electrodes 21a and 21b are formed on lower surfaces of the sustain electrodes 21a and 21b, respectively. The sustain electrodes 21a and 21b and the bus electrodes 22a and 22b are embedded by a transparent second dielectric layer 23. In addition, a protective layer 24 formed of MgO is formed on a lower surface of the second dielectric layer 23. The protective layer 24 prevents the second dielectric layer 23 from being damaged by sputtering of plasma particles, and emits secondary electrons to reduce the discharge voltage.

The plasma display panel having the above structure performs an address discharge and a sustain discharge. The address discharge occurs between the address electrode 11 and one of the sustain electrodes 21a and 21b, and wall charges are accumulated during the address discharge. Next, the sustain discharge occurs due to an electric potential difference between the pair of sustain electrodes 21a and 21b, and the phosphor layers 15 are excited by the ultraviolet rays generated during the sustain discharge, and thus, the visible light is emitted. In addition, the visible light transmits through the upper substrate, and thereby forms an image recognized by a user.

However, in the conventional plasma display panel, the upper substrate or the lower substrate is formed of a glass material, and thus, costs for manufacturing the substrate increase. In addition, since the relative dielectric constant of the glass is relatively high, invalid power consumption may increase when operating the plasma display panel, and the luminous efficiency is reduced.

### SUMMARY OF THE INVENTION

The present embodiments provide a gas excited emitting device and a flat panel display apparatus that can reduce invalid power consumption and improve luminous efficiency.

According to an aspect of the present embodiments, there is provided a gas excited emitting device, which emits light by exciting a gas, the device including: a first substrate and a second substrate facing each other with a substantially constant distance and forming a space in which an excitation gas is filled; a plurality of electrodes disposed between the first substrate and the second substrate; and an electron emission source, wherein at least one of the first substrate and the second substrate is a plastic substrate.

According to another aspect of the present embodiments, there is provided a flat panel display apparatus including: a first substrate and a second substrate facing each other with a predetermined distance and forming a plurality of cells between them; an excitation gas filled in the cells; phosphor layers formed on inner walls of the cells; a plurality of first electrodes formed on an inner surface of the first substrate; a plurality of second electrodes formed on an inner surface of the second substrate; a plurality of third electrodes formed on the first electrodes; and a first electron accelerating layer formed between the first electrodes and the third electrodes, and emitting a first electron beam that excites the excitation gas into the cells when voltages are applied to the first electrodes and the third electrodes, wherein at least one of the first substrate and the second substrate is a plastic substrate.

A relative dielectric constant of the plastic substrate may be at most about 5.5.

The density of the plastic substrate may be at most about 2.3 g/cm³.

One of the first substrate and the second substrate, which is a front substrate, may have an average transmittance at least about 90% with respect to the visible light.

The plastic substrate may be formed of one selected from the group consisting of a glass epoxy, a polyimide, a polyethylene terephthalate (PETF), a poly carbonate, and a polymethyl methacrylate (PMMA).

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display panel according to the conventional art;

FIG. 2 is a cross-sectional view of a part of the plasma display panel taken along line II-II of FIG. 1;

FIG. 3 is a schematic cross-sectional view of a flat panel display apparatus according to an embodiment;

FIG. 4 is a schematic cross-sectional view of a flat panel display apparatus according to another embodiment;

FIG. 5 is a schematic cross-sectional view of a gas excited emitting device according to an embodiment;

FIG. 6 is a graph illustrating an energy level of Xe according to an embodiment; and

FIG. 7 is a graph illustrating a relation between relative dielectric constants of plastic materials according to frequencies thereof according to an embodiment.

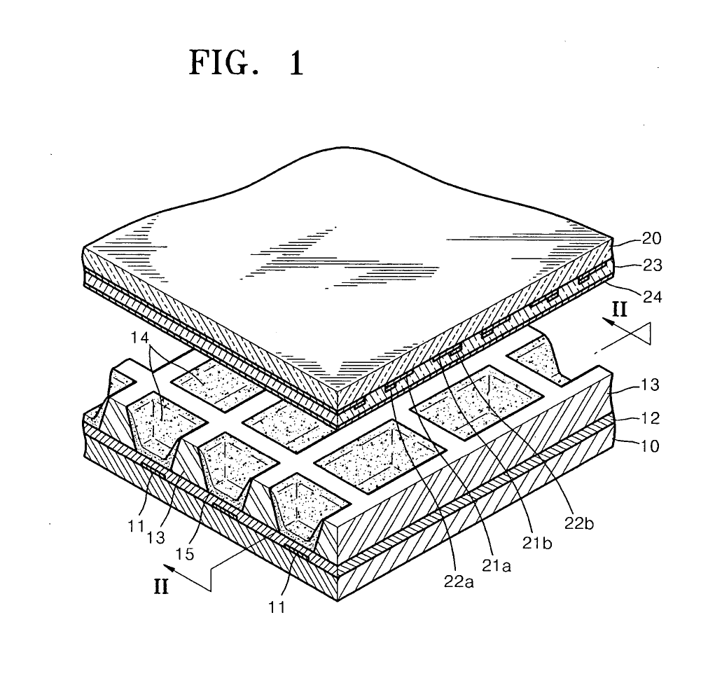

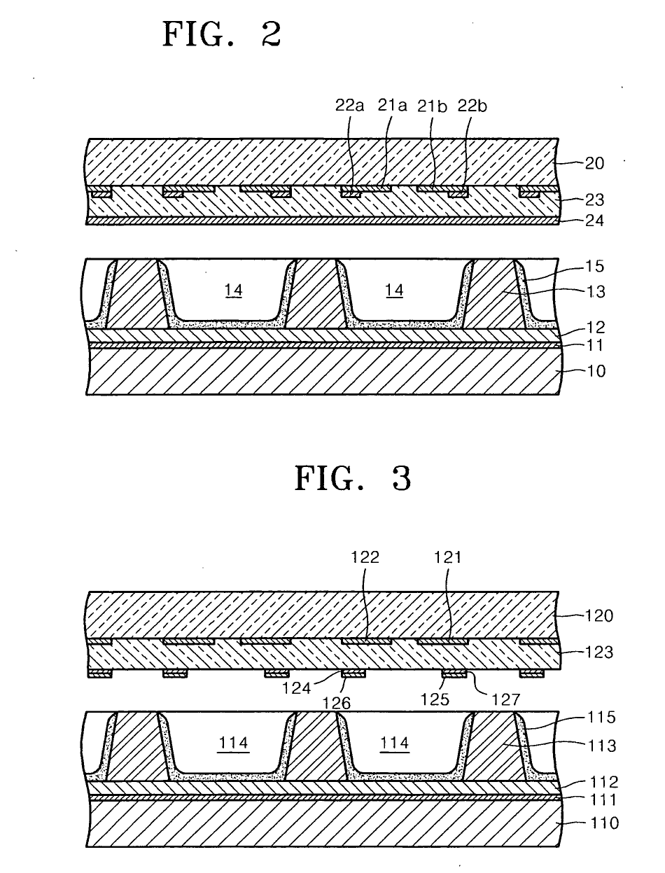

### DETAILED DESCRIPTION OF THE INVENTION

FIG. 3 is a schematic cross-sectional view of a part of a flat panel display apparatus according to some embodiments.

Referring to FIG. 3, a first substrate 110, which can be a lower substrate, and a second substrate 120, which can be an upper substrate, face each other with a predetermined distance therebetween. A plurality of barrier ribs 113 define a space between the first and second substrates 110 and 120 to form a plurality of cells 114 and prevent electrical and optical cross talk from generating between cells 114 and are formed between the first and second substrates 110 and 120. Red (R), green (G), and blue (B) phosphor layers 115 are applied on inner walls of the cells 114. In addition, an excitation gas generally including, for example, Xe is filled in the cells 114. The excitation gas is a gas that is excited by external energy such as electron beam and emits ultraviolet rays. In addition, the excitation gas can perform as a discharge gas.

Address electrodes 111 are formed on an upper surface of the first substrate 110 corresponding to the cells 114, and are embedded by a first dielectric layer 112. The barrier ribs 113 are formed on the first dielectric layer 112 to define the cells 114.

Meanwhile, pairs of sustain electrodes 121 and 122 are formed on a lower surface of the second substrate 120, and the pairs of the sustain electrodes 121 and 122 are embedded by a second dielectric layer 123. In addition, lower electrodes 127 and 124 that are aligned with the pairs of the sustain electrodes 121 and 122 are formed on a lower surface of the second dielectric layer 123. Electron emission sources 125 and 126 are respectively formed on lower surfaces of the lower electrodes 127 and 124.

The sustain electrodes 121 and 122 are disposed to cross the address electrodes 111. In addition, the sustain electrodes 121 and 122 can be formed of a transparent conductive material such as indium tin oxide (ITO) for example, so that the visible light can transmit through the sustain electrodes 121 and 122. Meanwhile, bus electrodes (not shown) can be formed on lower surfaces of the sustain electrodes 121 and 122.

The electron emission sources 125 and 126 can be formed of any material that can accelerate the electrons and emits electron beam, for example, they can be formed of oxidized porous silicon. The oxidized porous silicon (OPS) may be oxidized porous poly silicon or oxidized porous amorphous silicon.

In the present embodiment, the electron emission sources 125 and 126 are formed of the oxidized porous silicon. When a predetermined voltage is applied to the electron emission sources 125 and 126, electrons are injected into the electron emission source from the lower electrode. In an OPS layer or in the electron emission source, the diameter of a silicon nanocrystal is about 5 μm, and the diameter is much smaller than a mean free path (about 50 μm) of the electron in the silicon crystals, and thus, the electrons injected into the nanocrystals of silicon are less likely to collide with the crystals.

Therefore, the electrons pass through the nanocrystals of silicon, and reach the interface of the OPS layer. Since thin oxide layers are coated on the nanocrystals of silicon, most of the applied voltage forms a strong electric field area with the thin oxide layers between the nanocrystals of silicon. Since the oxide layers are very thin, the electrons can pass using a tunnelling phenomenon. Whenever the electrons pass through the strong electric field area, the electrons are accelerated. In addition, the acceleration occurs repeatedly toward the electrodes disposed at the surfaces, and thus, the electrons reaching the surfaces have higher energy than that of the electrons in a state of thermally equilibrium, that is, nearly same as the applied voltage. Therefore, the electrons pass the surface electrodes, and are emitted into the gas.

The electron beam emitted into the cell 114 excites the excitation gas, and the excited gas emits the ultraviolet rays while stabilizing. In addition, the ultraviolet rays excite the phosphor layer 115 to generate visible light, and the visible light is discharged through the second substrate 120 to form an image.

At least one of the first substrate 110 and the second substrate 120 can be a plastic substrate.

A plastic substrate may have a relative dielectric constant of at most about 5.5, and a density of the plastic substrate may be at most about 2.3 g/cm³. In addition, an average transmittance of the plastic substrate may be at least about 90% with respect to the visible light.

A plastic substrate may be formed of at least one selected from the group consisting of a glass epoxy, a polyimide, a polyethylene terephthalate (PETF), a polycarbonate, and a polymethyl methacrylate (PMMA). The plastic substrate having the transmittance of at least about 90% for the visible light may be mainly formed of the polycarbonate or PMMA.

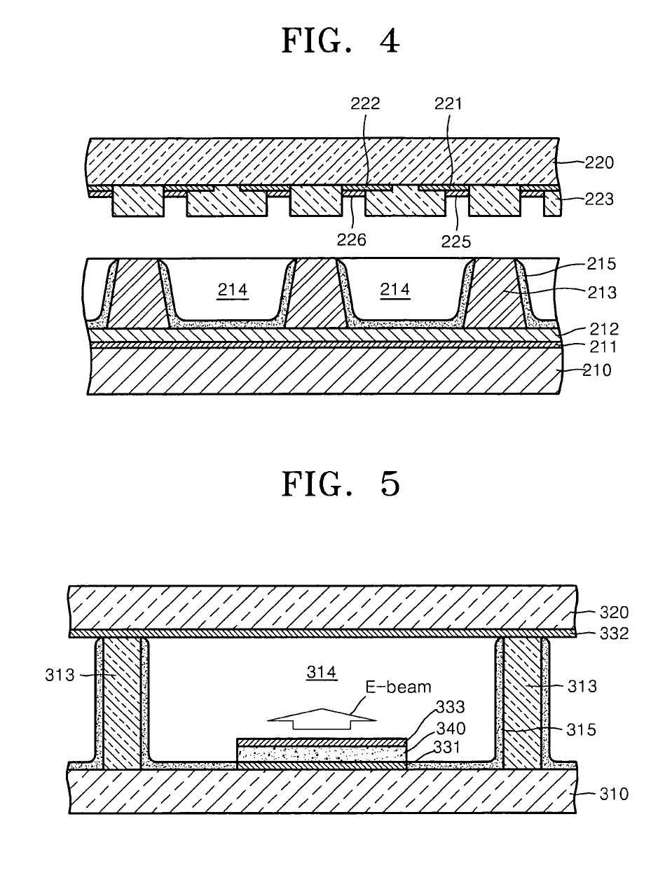

FIG. 4 is a schematic cross-sectional view of a part of a flat panel display apparatus according to another embodiment.

Referring to FIG. 4, a first substrate 210, which can be a lower substrate, and a second substrate 220, which can be an upper substrate, face each other with a predetermined distance therebetween. A plurality of barrier ribs 213 define a space between the first and second substrates 210 and 220 to form a plurality of cells 214 and prevent electrical and optical cross talk from generating between cells 214 and are formed between the first and second substrates 210 and 220. Red (R), green (G), and blue (B) phosphor layers 215 are applied on inner walls of the cells 214. In addition, an excitation gas generally including Xe, for example, is filled in the cells 214. The excitation gas in the present embodiments is a gas that is excited by external energy such as electron beam and emits ultraviolet rays. In addition, the excitation gas can perform as a discharge gas.

Address electrodes 211 are formed on an upper surface of the first substrate 210 corresponding to the cells 214, and are embedded by a first dielectric layer 212. The barrier ribs 213 are formed on the first dielectric layer 212 to define the cells 214.

Meanwhile, pairs of sustain electrodes 221 and 222 are formed on a lower surface of the second substrate 220, and the pairs of the sustain electrodes 221 and 222 are embedded by a second dielectric layer 223. However, electron emission sources 225 and 226 formed on a lower surface of the sustain electrodes 221 and 222 are not embedded by the second dielectric layer 223, but are exposed toward the cells 214. That is, the second dielectric layer 223 includes recesses on portions corresponding to the electron emission sources 225 and 226 so that the electron emission sources 225 and 226 can be exposed through the recesses.

The sustain electrodes 221 and 222 are disposed to cross the address electrodes 211. The lower sustain electrodes 221 and 222 can be formed of a transparent conductive material such as ITO. In addition, bus electrodes (not shown) can be formed on lower surfaces of the sustain electrodes 221 and 222.

The electron emission sources 225 and 226 can be formed of any material that can accelerate the electrons and emits electron beam, for example, they can be formed of oxidized porous silicon (OPS). The oxidized porous silicon may be oxidized porous poly silicon or oxidized porous amorphous silicon.

In the present embodiment, the electron emission sources 225 and 226 are formed of the oxidized porous silicon. When a predetermined voltage is applied to the electron emission sources 225 and 226, electrons are injected into the electron emission source from the lower electrode. In the OPS layer, that is, in the electron emission source, diameter of silicon nanocrystal is about 5 μm, and the diameter of the nanocrystal of silicon is much smaller than a mean free path (about 50 μm) of the electron in the silicon crystals, and thus, the electrons injected into the nanocrystals of silicon are less likely to collide with the crystals.

Therefore, the electrons pass through the nanocrystals of silicon, and reach an interface of the OPS layer. Since thin oxide layers are coated on the nanocrystals of silicon, most of the applied voltage forms a strong electric field area with the thin oxide layers between the nanocrystals of silicon. Since the oxide layers are very thin, the electrons can pass using a tunnelling phenomenon. Whenever the electrons pass through the strong electric field area, the electrons are accelerated. In addition, the acceleration occurs repeatedly toward the electrodes disposed at the surfaces, and thus, the electrons reaching the surfaces have higher energy than that of the electrons in a state of thermally equilibrium, that is, nearly same as the applied voltage. Therefore, the electrons pass the surface electrodes, and are emitted into the gas.

Here, the electron beam emitted into the cell 214 excites the excitation gas, and the excited gas emits the ultraviolet rays while stabilizing. In addition, the ultraviolet rays excite the phosphor layer 215 to generate visible light, and the visible light is discharged through the second substrate 220 to form an image.

At least one of the first substrate 210 and the second substrate 220 can be a plastic substrate.

A plastic substrate may have a relative dielectric constant of at most about 5.5, and a density of the plastic substrate may be at most about 2.3 g/cm³. In addition, an average transmittance of the plastic substrate may be at least about 90% with respect to the visible light.

The plastic substrate may be formed of at least one selected from the group consisting of a glass epoxy, a polyimide, a PETF, a polycarbonate, and a PMMA. The plastic substrate having the transmittance of 90% or higher for the visible light may be formed of the polycarbonate or PMMA mainly.

FIG. 5 is a schematic cross-sectional view of a gas excited emitting device according to an embodiment.

Referring to FIG. 5, a first substrate 310, which can be a lower substrate, and a second substrate 320, which can be an upper substrate, face each other with a predetermined distance therebetween. A plurality of barrier ribs 313 defining a space between the first and second substrates 310 and 320 to form a plurality of cells 314 and preventing electrical and optical cross talk from generating between cells 314 are formed between the first and second substrates 310 and 320. Red (R), green (G), and blue (B) phosphor layers 315 are applied on inner walls of the cells 314. In addition, an excitation gas generally including Xe, for example, is filled in the cells 314. The excitation gas is a gas that is excited by external energy such as electron beam and emits ultraviolet rays. In addition, the excitation gas can perform as a discharge gas.

A first electrode 331 is formed at each of the cells 314 on an upper surface of the first substrate 310, and a second electrode 332 is formed at each of the cells 314 on a lower surface of the second substrate 320 in a direction of crossing the first electrodes 331. The first and second electrodes 331 and 332 are a cathode and an anode, respectively. The second electrode 332 may be formed of a transparent conductive material such as ITO so that visible light can transmit through the second electrode 332. In addition, a dielectric layer (not shown) may be further formed on the second electrode 332.

An electron emission source 340 is formed on an upper surface of the first electrode 331, and a third electrode 333, that is, a grid electrode, is formed on the electron emission source 340. The electron emission source 340 can be formed of any material that can accelerate the electrons and emits an electron beam, for example, they can be formed of oxidized porous silicon (OPS). The oxidized porous silicon may be oxidized porous poly silicon or oxidized porous amorphous silicon.

When predetermined voltages are applied to the first and third electrodes 331 and 333 respectively, the electron emission source 340 accelerates electrons induced from the first electrode 331 and emits an electron beam into the cell 314 through the third electrode 333. The electron beam emitted into the cell 314 excites the gas, and the excited gas generates ultraviolet rays while stabilizing. In addition, the ultraviolet rays excite the phosphor layer 315 to generate visible light, and the visible light exits through the second display the image.

The electron beam may have an energy level higher than that required to excite the excitation gas and lower than that required to ionize the excitation gas. Therefore, voltages having electron energies optimized for exciting the excitation gas are applied to the first and third electrodes 331 and 333.

The electron emission source can increase the electrons emitting from the anode to reduce the discharge voltage, and reduce the energy required to ionize the electrons and accelerate ions to improve discharge efficiency. Moreover, the electrons required to emit light can be supplied from the electron emission source, and thus, a discharge does not occur and energy loss due to the ions can be prevented.

Referring to FIG. 5, in a case where an OPS layer is used as the electron emission source 340, the energy of the output electrons can be controlled by using the voltages applied between the first electrode 331, that is, the cathode, and the third electrode 333, that is, the grid electrode. Therefore, the energy of the electrons is controlled to be higher than the excitation energy of the gas and lower than the ionization energy of the gas, and thus, the gas can be excited without a discharge. In addition, according to the structure of FIG. 5, the size of the cell does not affect the energy efficiency, and thus, it is easy to form a super-fine display device.

At least one of the first substrate 310 and the second substrate 320 can be a plastic substrate.

A plastic substrate may have a relative dielectric constant of 5.5 or smaller, and a density of the plastic substrate may be 2.3 g/cm³ or less. In addition, an average transmittance of the plastic substrate may be 90% or higher with respect to the visible light.

The plastic substrate may be formed of at least one selected from the group consisting of a glass epoxy, a polyimide, a PETF, a polycarbonate, and a PMMA. The plastic substrate having the transmittance of at least about 90% for the visible light may be formed of the polycarbonate or PMMA mainly.

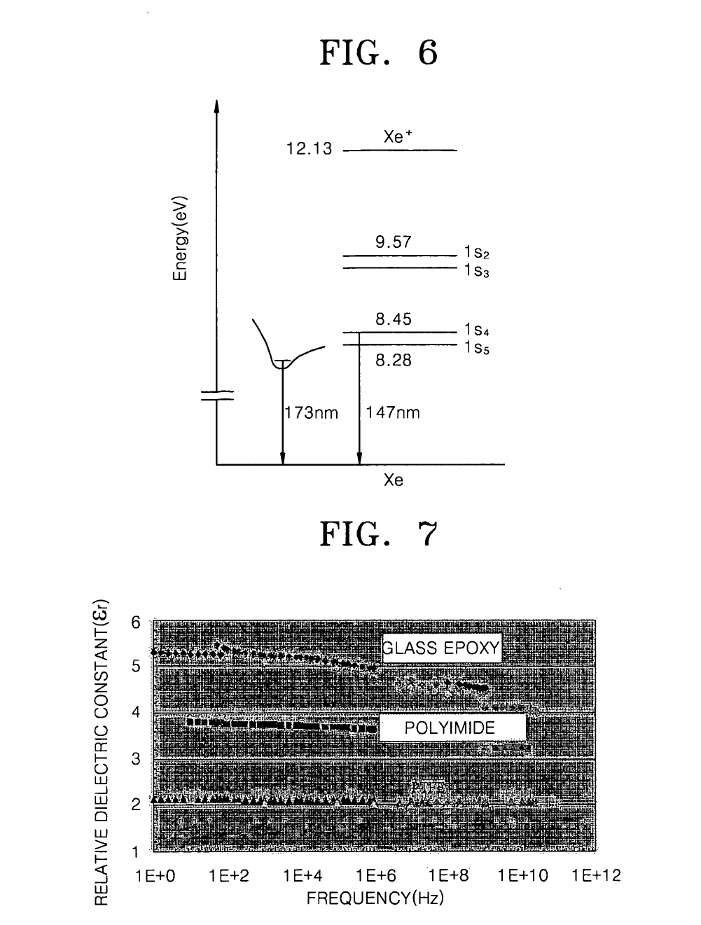

FIG. 6 illustrates an energy level of Xe that is a source for generating ultraviolet rays. Referring to FIG. 6, energy of 12.13 eV is required to ionize Xe, and 8.28 eV or more energy is required to excite Xe. In order to excite Xe to states of 1S₅, 1S₄, and 1S₂, energies 8.28 eV, 8.45 eV, and 9.57 eV respectively are required. The excited Xe (Xe⁺) generates ultraviolet rays of 147 nm wavelength while stabilizing. In addition, when Xe⁺ of excited status collides with Xe of ground state, excimer Xe (Xe²⁺) is generated. When the excimer Xe (Xe²⁺) is stabilized, the ultraviolet rays having about 173 nm wavelength is generated.

Accordingly, in the device of FIG. 5, the electron beam that is emitted into the cell 314 by the electron emission source 340 can have an energy level of from about 8.28 eV to about 12.13 eV in order to excite Xe. Then, the electron beam may have the energy level from about 8.28 eV to about 9.57 eV or from about 8.28 eV to about 8.45 eV. Otherwise, the electron beam may have the energy level from about 8.45 eV to about 9.57 eV.

Meanwhile, FIG. 7 is a graph illustrating changes of relative dielectric constants of plastic materials according to frequencies of the materials. In particular, in the flat panel display and the gas excited emitting device according to the present embodiments, the first substrate or the second substrate is formed as a plastic substrate, the reason why the first or second substrate can be formed as a plastic substrate having a certain property will be described as follows.

If at least one of the first and second substrates that include a gas sealed therebetween is formed of the plastic material, a less expensive device having light weight can be manufactured. In addition, since the dielectric constant of the plastic is generally lower than that of the glass, therefore a dielectric capacitance of the substrate can be reduced, and thus, invalid power consumption during driving the panel is reduced and luminous efficiency is improved.

The above effects can be obtained by generating the electrons for exciting the gas using the electron emission source without generating a discharge or by generating a discharge with low voltage to reduce the heat transmitted to the first and second substrates.

Referring to FIG. 7, a relative dielectric constant of the glass epoxy is from about 4.1 to about 5.4, a relative dielectric constant of a polyimide is from about 3.2 to about 3.8, and a relative dielectric constant of PTFE is from about 2 to about 2.2.

The dielectric capacitance of the substrate that is formed of the above materials is just from about ⅔ to about ¼ of the dielectric capacitance of the conventional glass substrate (a relative dielectric constant of PD200, which is an example of the glass for forming plasma display panel, is about 7.9). Therefore, the energy loss, that is, invalid power consumption, which is in proportion to the dielectric capacitance, can be reduced.

Referring to following Table 1, since the plastic is lighter than the glass, a weight of a device using the plastic as a substrate can be reduced. In case of the plasma display panel, the upper and lower substrates occupy the largest amount of the weight of the panel. Therefore, if the material having a low density is used to form the substrate, the entire weight of the panel can be prominently reduced.

TABLE 1

| Material | Density (g/cm³) |
|---|---|
| PD200 | 2.77 |
| Glass epoxy | 1.6-2.2 |
| Polyimide | 1.2 |
| PETF | 2.1-2.3 |

In addition, since the visible light transmits through the upper surface to form the image, the transmittance of the substrate with respect to the visible light is an important factor for selecting the material of the substrate.

Table 2 illustrates examples of plastic materials that have relatively high transmittance for the visible light and can be used to form the front substrate.

TABLE 2

| | | | Relative |
|---|---|---|---|
| | Density | Transmittance | dielectric |
| Material | (g/cm³) | (t = 2.8 mm) | constant |
| PD200 | 2.77 | Exceed 99 | 7.9 |
| Polycarbonate | 1.2 | 97 | 3 |
| PMMA | 1.19 | Exceed 99 | 3.5-4.5 |

Since the plastic materials shown in above Table 2 have low relative dielectric constants, that is, from about 3 to about 4.5, the electric capacitance of the substrate that is formed of the above materials is from about ⅔ to about ¼ of that of the conventional glass substrate, and the invalid power consumption can be reduced. In addition, as shown in Table 2, the density of the plastic material is about half of the glass forming the plasma display panel or lower, and thus, the weight of the panel can be reduced.

According to the flat panel display apparatus of the present embodiments, since the plastic substrate is used, the weight of the substrate occupying a large amount of the panel weight and costs for fabricating the substrate can be reduced.

In addition, the dielectric capacitance of the substrate can be reduced, and thus, the invalid power consumption when driving the panel can be reduced.

Also, the light transmittance of the panel is good, and thus, the luminous efficiency of the panel can be improved.

Since the electron emission source is formed at an appropriate position, the electrons having the energy required to excite the gas can be generated without causing a discharge, or can be generated by causing the discharge at a low voltage to reduce the heat transmitted to the upper and lower substrates.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A gas excited emitting device, which emits light by exciting a gas, the device comprising:
a first substrate and a second substrate facing each other with a substantially constant distance and forming a space in which an excitation gas is filled;
a plurality of electrodes disposed between the first substrate and the second substrate; and
an electron emission source,
wherein at least one of the first substrate and the second substrate is a plastic substrate.

2. The device of claim 1, wherein a relative dielectric constant of the plastic substrate is at most about 5.5.

3. The device of claim 2, wherein a density of the plastic substrate is at most about 2.3 g/cm³.

4. The device of claim 2, wherein one of the first substrate and the second substrate, which is a front substrate, has an average transmittance of at least about 90% with respect to visible light.

5. The device of claim 2, wherein the plastic substrate is formed of one selected from the group consisting of a glass epoxy, a polyimide, a polyethylene terephthalate (PETF), a polycarbonate, and a polymethyl methacrylate (PMMA).

6. A flat panel display apparatus comprising:
a first substrate and a second substrate facing each other with a predetermined distance and forming a plurality of cells between them;
an excitation gas filled in the cells;
phosphor layers formed on inner walls of the cells;
a plurality of first electrodes formed on an inner surface of the first substrate;
a plurality of second electrodes formed on an inner surface of the second substrate;
a plurality of third electrodes formed on the first electrodes; and
a first electron accelerating layer formed between the first electrodes and the third electrodes configured to emit a first electron beam that excites the excitation gas into the cells when voltages are applied to the first electrodes and the third electrodes,
wherein at least one of the first substrate and the second substrate is a plastic substrate.

7. The flat panel display apparatus of claim 6, wherein a relative dielectric constant of the plastic substrate is at most about 5.5.

8. The apparatus of claim 6, wherein a density of the plastic substrate is at most about 2.3 g/cm³.

9. The apparatus of claim 6, wherein one of the first substrate and the second substrate, which is a front substrate, has an average transmittance of at least about 90% or higher with respect to the visible light.

10. The apparatus of claim 6, wherein the plastic substrate is formed of one selected from the group consisting of a glass epoxy, a polyimide, a polyethylene terephthalate (PETF), a polycarbonate, and a polymethyl methacrylate (PMMA).

11. The apparatus of claim 6, wherein the second electrodes are formed in a direction crossing the first electrodes.
